(19) United States
(12) Patent Application Publication
(10) Pub. No.: US 2009/0097976 A1
(43) Pub. Date: Apr. 16, 2009

(54) ACTIVE DAMPING OF WIND TURBINE BLADES

(75) Inventors: Howard D. Driver, Greer, SC (US); Stefan Herr, Greenville, SC (US); Kevin W. Kinzie, Moore, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/872,239

(22) Filed: Oct. 15, 2007

(51) Int. Cl. F03D 7/00; F01D 5/14; F03D 9/00

(52) U.S. Cl. 416/42; 416/61; 416/223 R; 290/55

(57) ABSTRACT

A wind turbine blade, includes a sensor, arranged upstream from a trailing edge of the blade for measuring an airflow characteristic near a surface of the blade; and an actuator, arranged downstream from the sensor, for adjusting the airflow in response to the measured characteristic.

### BACKGROUND OF THE INVENTION

1. Technical Field

The subject matter described here generally relates to fluid reaction surfaces with vibration damping features, and, more particularly to active damping for wind turbine blade noise and/or drag reduction.

2. Related Art

A wind turbine is a machine for converting the kinetic energy in wind into mechanical energy. If that mechanical energy is used directly by machinery, such as to pump water or to grind wheat, then the wind turbine may be referred to as a windmill. Similarly, if the mechanical energy is further transformed into electrical energy, then the turbine may be referred to as a wind generator or wind power plant.

Wind turbines use one or more airfoils in the form of a “blade” to generate lift and capture momentum from moving air that is them imparted to a rotor. Each blade is typically secured at its “root” end, and then “spans” radially “outboard” to a free, “tip” end. The front, or “leading edge,” of the blade connects the forward-most points of the blade that first contact the air. The rear, or “trailing edge,” of the blade is where airflow that has been separated by the leading edge rejoins after passing over the suction and pressure surfaces of the blade. A “chord line” connects the leading and trailing edges of the blade in the direction of the typical airflow across the blade.

Wind turbines are typically categorized according to the vertical or horizontal axis about which the blades rotate. One so-called horizontal-axis wind generator is schematically illustrated in FIG. 1. This particular configuration for a wind turbine 2 includes a tower 4 supporting a drive train 6 with a rotor 8 that is covered by a protective enclosure referred to as a “nacelle.” The blades 10 are arranged at one end of the rotor 8 outside the nacelle for driving a gearbox 12 connected to an electrical generator 14 at the other end of the drive train 6 inside the nacelle.

Although wind energy is one of the fastest growing sources of renewable energy, wind turbine noise is still a major obstacle to implementation. For large, modern wind turbines, aerodynamic noise is considered to be the dominant source of this noise problem, and, in particular, so-called “trailing edge noise” caused by the interaction of turbulence in the boundary layer with the trailing edge of the blade.

The boundary layer is a very thin sheet of air lying over the surface of the blade 10. Because air has viscosity, this layer of air tends to adhere to the blade 10. As the blade 10 moves, air in the boundary layer region near the leading edge at first flows smoothly over the streamlined shape of the blade 10 in what is referred to as “laminar flow.” However, as the air continues to flow further along the chord of the blade 10, the thickness of this boundary layer of slow moving air increases due to friction with the blade. At some distance along the chord of the blade a turbulent layer, characterized by eddies and vortices, may begin to form over the laminar layer. The thickness of the turbulent layer will then increase, and the thickness of the laminar layer will decrease, as the air moves further along the surface of the blade 10. The onset of transition flow, where the boundary layer changes from laminar to turbulent is called the “transition point,” and is where drag due to skin fiction becomes relatively high. This transition point tends to move forward on the chord of the blade 10 as the speed and angle of attack of the blade increases, resulting in more drag and more noise-causing turbulence.

### BRIEF DESCRIPTION OF THE INVENTION

These and other aspects of such conventional approaches are addressed here by providing, in various embodiments, a wind turbine blade including a sensor, arranged upstream from a trailing edge of the blade, for measuring an airflow characteristic near a surface of the blade; and an actuator, arranged downstream from the sensor, for adjusting the blade in response to the measured airflow characteristic. Also disclosed here is a wind generator, including a tower supporting a drive train with a rotor; at least one blade extending radially from the rotor; means, arranged upstream from a trailing edge of the blade, for sensing an airflow characteristic near a surface of the blade; means, arranged downstream from the sensing means, for actuating a portion of the blade in response to the sensed airflow characteristic; and means for regulating the actuating means in response to a signal from the sensing means. In another embodiment, the technology disclosed here relates to a method of reducing noise from a wind turbine blade, including sensing an airflow characteristic at location near a surface of the blade upstream from a trailing edge of the blade; and actuating a portion of the blade downstream from the sensing location in response to the sense airflow characteristic.

### BRIEF DESCRIPTION OF THE DRAWINGS

Various aspects of this technology invention will now be described with reference to the following figures (“FIGS.”) which are not necessarily drawn to scale, but use the same reference numerals to designate corresponding parts throughout each of the several views.

FIG. 1 is a schematic side view of a conventional wind turbine.

FIG. 2 is a schematic, partial cross-sectional illustration of a wind turbine blade.

FIG. 3 is an operational diagram of the wind turbine blade shown in FIG. 2.

### DETAILED DESCRIPTION OF THE INVENTION

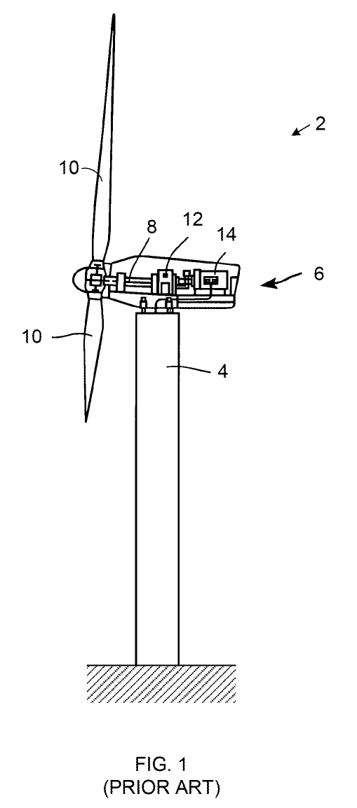

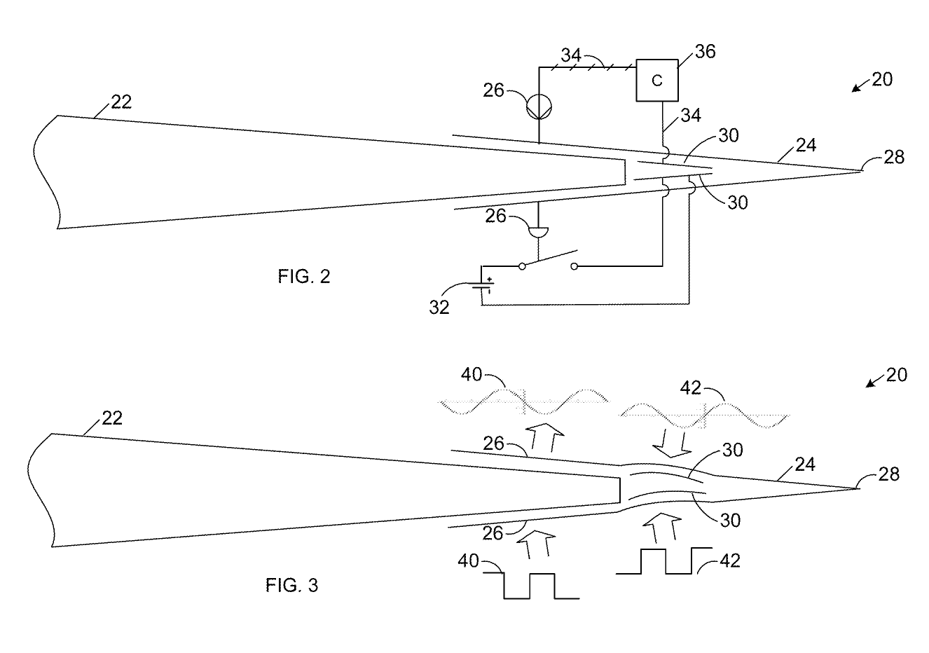

FIGS. 2 and 3 are schematic, partial cross-sectional view of a wind turbine blade 20 for use with the wind generator shown in FIG. 1, or any other wind turbine. For example, the blade 20 illustrated in FIG. 2 may replace any and/or all of the conventional blades 10 illustrated in FIG. 1. In the illustrated examples, the turbine blade 20 includes a main body 22 and a trailing edge cap 24 as disclosed in copending U.S. patent application Ser. No. 11/193,696 (Attorney Docket No. 167650). corresponding to Patent Publication No. 2007/0025858. However, the technology discussed below may also be applied in a variety of other configurations, including, but not limited to directly to the main body 22 of the blade 20, without the trailing edge cap 24.

In the illustrated examples, the blade 20 includes a sensor 26 arranged upstream from a trailing edge 28 of the blade 20, opposite from the direction of airflow over the corresponding surface of the blade, for measuring an airflow characteristic near a surface of the blade. Any flow characteristic may be measured including turbulence, speed, direction, rate of flow, temperature, boundary layer height, and/or pressure, including dynamic and/or static pressure. For example, the sensor 26 may be configured as a flow transducer, such as the pressure transducer illustrated on the upper (suction) side of the blade 20. Alternatively, or in addition, the sensor 26 may include a hot wire sensor, five-hole probe, or laser for measuring one or more flow characteristics in one or more spatial dimensions. The sensor 26 may also include additional functionality, such as regulating, powering, switching and/or communicating. For example the sensor 26 may be configured as a flow relay, such as the pressure switch illustrated on the lower (pressure) side of the blade 20.

An actuator 30 is arranged downstream from the sensor 26, in a direction of airflow over the corresponding surface of the blade, for adjusting the blade 20 in response to the measured airflow characteristic. Any actuator may be used, including linear and/or rotational mechanical, pneumatic, hydraulic, thermal, and/or electric actuators. For example, the actuator 30 may be configured as a piezoelectric transducer, such as the piezoelectric strips illustrated in FIGS. 2 and 3 where those strips are secured to an internal surface of the trailing edge cap 24. Alternatively, the piezoelectric strips may be secured to an external surface, to both internal and external surfaces of the trailing edge cap 24. For example, in one configuration for piezoelectric strip actuators, a metal layer may be sandwiched between multiple transduction layers arranged on the surface of the trailing edge cap 24 or other portion of the blade 20. Alternatively, or in addition, the actuator may be configured as plasma generator. For example, the plasma generator may be configured as one or more electrodes driven by one or more pulsed signals, pulse envelopes, and/or high voltage radio signals. The actuator 30 may also include additional functionality, such as regulating, powering, switching, and/or communicating. A continuous strip of integrated actuators may also be used.

Although the sensor(s) 26 and actuator(s) 30 are illustrated as being arranged on both upper (suction) and lower (pressure) surfaces of the blade 20, they may also be arranged on opposite surfaces, both surfaces, and/or only one surface, of the blade 20. Multiple sensors 26 and/or actuators 30 may also be arranged along the span and/or chord of the blade 20, and the sensors and actuators may be spaced closer or further apart than shown in the Figures, which are not drawn to scale. Furthermore, some or all of the sensor(s) 26 and actuator(s) 30 on opposite surfaces of the blade 20 may be arranged to operate independently of each, or in conjunction with each other. For example, their response may be coordinated by the controller 36 to achieve an optimum result when two flows meet at the trailing edge 28 of the blade 30.

In FIG. 2, the pressure sensing switch 26 on the lower (pressure) surface of the blade 20 is connected to a battery 32, or other power source. When the sensed pressure upstream of the trailing edge 28 rises above a set level, the switch 26 closes in order to provide a voltage to the piezoelectric actuator 30 secured inside the lower (pressure) surface of the trailing edge cap 24. The piezoelectric actuator 30 then changes shape to adjust the lower (pressure) surface of the blade as described below with respect to FIG. 3.

In addition to such a simple, binary control algorithm using an electrical circuit, the actuator 30 may regulated in response to a signal from the sensor 26 using more sophisticated control and/or communication methodologies. For example, the illustrated pressure sensing transducer 26 on the upper (suction) surface is connected via a signal line 34 to a controller 36 which then drives the piezoelectric actuator 30. The signal line 34 may include any signal communication medium including twisted pair wires, pneumatic tubing, hydraulic tubing, coaxial cable, fiber optic cable, and/or wireless transmission mediums such as radio, microwave, and/or satellite links. Various communication protocols may also be used, including, but not limited to, serial, parallel, TCP/IP, OLE for process control, Common Interface Protocol, DeviceNet, EtherNet, Modbus, SINEC and/or GE SRTP.

The controller 36 regulates the actuator 30 in response to the signal from the sensor 26. The controller may use any control methodology, including, but not limited to, binary, proportional-integral-derivative (P-I-D), feedback, feedforward, discrete batch, continuous, open-loop, closed-loop, logical, fuzzy logic, distributed and/or control methodologies. In this regard, the controller 36 may include an analogue controller and/or a programmable controller, such as a digital computer. The controller 36 may be configured to drive the actuator 30 in various control schemes in order to reduce noise and/or delay the onset of transition flow. For example, the controller 36 may be configured so that the (pressure) actuator 30 provides an acoustic, noise-cancelling output that is substantially out of phase with the pressure noise, or other flow characteristic, sensed by the sensor 26. Alternatively, or in addition, the controller 36 may be configured drive the (plasma generating) actuator 30 so as to cause a change in direction of the flow and/or otherwise delay the onset of transition flow. In the latter configuration, at least some of the actuators 30 would typically be arranged close to the leading edge of the blade 20 where transition flow was likely to begin.

In fact, various embodiments of the control methodology implemented by the controller 36 can be implemented in hardware, software, firmware, or a combination thereof. Suitable hardware may includes, but is not limited to, any technology such as discrete logic circuit(s) having logic gates for implementing logic functions upon data signals, application specific integrated circuit (ASIC) having appropriate combinational logic gates, a programmable gate array(s) (PGA), a field programmable gate array (FPGA), etc. Alternatively, or in addition, the software or firmware may be stored in a memory and that is executed by a suitable instruction execution system.

Any such software program will comprise an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples of the computer-readable medium include, but are not limited to, an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

FIG. 3 schematically illustrates the blade 20 from FIG. 2 in a typical mode of operation. As illustrated by the upper (suction) surface in FIG. 3, the (pressure sensing transducer) sensor 26 will provide data on the sensed flow characteristic 40 (pressure) to the controller 36. Although the sensed flow characteristic data 40 from the sensor 26 is illustrated as a real-time continuous wave form, other types of data may also be sensed and/or collected including, but not limited to, discontinuous, discrete, abstract, algebraic, and/or other data types, and not necessarily in real-time. The sensed flow characteristic data is then sent to the controller 36 which regulates and/or drives the actuator 30 with a control signal 42 in response to the sensed data signal 40. Similarly, as illustrated by the lower (pressure) surface in FIG. 3, the (pressure sensing switch) sensor 26 will sense the flow characteristic (pressure) 40 and use that information to open and close the switch and drive the actuator 30 according to the control signal 42.

Although the control signal 42 is also illustrated as a real-time continuous wave form which is inverse to the sensed flow characteristic data signal 40, other output control signals may also be used including, but not limited to, discontinuous, discrete, abstract, algebraic, and/or other signal types. For example, the algorithm that is used to transform the input data from the sensor 26 into instructions for driving the actuator 30 may be a suitable noise cancellation algorithm where a mirrored waveform from the sensor is “played” into the transducer utilizing so-called active noise cancellation. Alternatively, or in addition, the input waveform from the sensor 26 could be to separated into component frequencies or frequency ranges so that these various frequency components may be used to drive different actuators 30 in the same or different areas of the trailing edge cap 24. Certain events, such as laminar separation bubbles and blunt trailing edge vortex shedding that may be associated with individual tonal frequencies, could thus be specifically addressed using one or more of these frequency components.

In FIG. 3, a portion of each side of the trailing edge cap 24 is adjusted or deflected so as to be changed in shape by corresponding actuator 30. For the illustrated and non-limiting example, the trailing edge cap 24 is deflected outward by the actuator(s) 30 when low pressure is detected by the sensor(s) 26 as shown by the upper (pressure) surface of the blade 20. Similarly, the trailing edge cap 44 is deflected inward by the actuator(s) 30 when high pressure is detected by the sensor(s) 26 as shown by the lower (pressure) surface of the blade 20. Thus the shape of the trailing edge cap 24 on the blade 20 is adjusted to compensate for the pressure sensed near the surface of the blade before or while that portion of the flow moves downstream over the trailing edge 28 of the blade 20. In this way, the flow passing the trailing edge 28 of the blade 20 can be stabilized so as to minimize the aerodynamic noise produced by the blade. These and other embodiments described above therefore offer various advantages over conventional approaches including quieter operation with less drag and greater aerodynamic efficiency than conventional approaches.

The technology described above may also be combined with various other noise reduction technologies for wind turbines, including wind turbine blades with trailing edge serrations, such as, but not limited to, those disclosed in commonly-owned co-pending U.S. patent application Ser. No. 11/857,844 (Attorney Docket No, 227892) and the references cited in that matter. For example, the actuator 30 may be arranged to actuate serrations arranged at or near the trailing edge, and/or other portions of the blade 20.

It should be emphasized that the embodiments described above, and particularly any “preferred” embodiments, are merely examples of various implementations that have been set forth here to provide a clear understanding of various aspects of this technology. It will be possible to alter many of these embodiments without substantially departing from scope of protection defined solely by the proper construction of the following claims.

What is claimed is:

1. A wind turbine blade, comprising:
a sensor, arranged upstream from a trailing edge of the blade, for measuring an airflow characteristic near a surface of the blade; and
an actuator, arranged downstream from the sensor, for adjusting the airflow in response to the measured characteristic.

2. The wind turbine blade recited in claim 1, wherein the actuator adjusts a surface of the blade.

3. The wind turbine blade recited in claim 2, wherein the actuator changes a shape of the surface of the blade.

4. The wind turbine blade recited in claim 3, wherein the actuator comprises a piezoelectric strip.

5. The wind turbine blade recited in claim 1, wherein the sensor includes a pressure sensor.

6. The wind turbine blade recited in claim 3, wherein the sensor includes a pressure sensor.

7. The wind turbine blade recited in claim 4, wherein the sensor includes a pressure sensor.

8. The wind turbine blade recited in claim 7, further comprising a controller for regulating the actuator in response to a signal from the pressure sensor.

9. A wind generator, comprising:
a tower supporting a drive train with a rotor;
at least one blade extending radially from the rotor;
means, arranged upstream from a trailing edge of the blade, for sensing an airflow characteristic near a surface of the blade;
means, arranged downstream from the sensing means, for adjusting the airflow in response to the sensed characteristic; and
means for regulating the adjusting means in response to a signal from the sensing means.

10. The wind generator recited in claim 9, wherein the sensing means comprises a pressure sensor.

11. The wind generator recited in claim 9, wherein the adjusting means comprises a piezoelectric strip for changing a shape of the blade.

12. The wind generator recited in claim 10, wherein the adjusting means comprises a piezoelectric strip for changing a shape of the blade.

13. A method of reducing noise from a wind turbine blade, comprising:
sensing an airflow characteristic at location near a surface of the blade upstream from a trailing edge of the blade; and
actuating a portion of the blade downstream from the sensing location in response to the sense airflow characteristic.

14. The method recited in claim 13, wherein the airflow characteristic is pressure.

15. The method recited in claim 13, further comprising controlling the actuating step in response to the sensed airflow characteristic.

16. The method recited in claim 14, further comprising controlling the actuating step in response to the sensed airflow characteristic.

17. The method recited in claim 15, further comprising controlling the actuating step in response to the sensed airflow characteristic.

18. The wind turbine blade recited in claim 1, wherein the actuator comprises a plasma generator.

19. The wind turbine blade recited in claim 10, wherein the actuator comprises a plasma generator.

20. The wind turbine blade recited in claim 19, wherein the plasma generator delays onset of transition flow.
